(19) United States
(12) Patent Application Publication
(10) Pub. No.: US 2017/0298736 A1
(43) Pub. Date: Oct. 19, 2017

(54) RADIAL TURBOMACHINE

(71) Applicant: EXERGY S.P.A., Bologna (IT)

(72) Inventors: Claudio SPADACINI, Verbania Suna (VB) (IT); Dario RIZZI, Bisuschio (VA) (IT)

(73) Assignee: EXERGY S.P.A., Bologna (IT)

(21) Appl. No.: 15/330,801

(22) PCT Filed: Apr. 30, 2015
(86) PCT No.: PCT/IB2015/053157

§ 371 Date: Nov. 7, 2016

(30) Foreign Application Priority Data
May 5, 2014 (IT) MI2014A000811

(51) Int. Cl. F01D 5/04; F01D 11/00

(52) U.S. Cl. CPC F01D 5/041; F01D 11/001; F05D 2230/70; F05D 2230/60

(57) ABSTRACT

A radial turbomachine has: a fixed casing; at least one rotor disc installed in the casing and rotatable in the casing around a respective rotation axis; a plurality of annular rotor elements coaxial with the rotation axis, axially projecting from a front face of the rotor disc and/or from a rear face of the rotor disc; a plurality of annular fixed elements coaxial with the rotation axis, axially projecting from the casing and each positioned in a radially external position with respect to a respective annular rotor element; a plurality of sealing devices radially interposed between at least some of said annular rotor elements and the respective annular fixed elements.

### FIELD OF THE FINDING

The object of the present invention is a radial turbomachine. By radial turbomachine, it is intended a turbomachine in which the flow of the fluid with which it exchanges energy is mainly directed in a radial sense with respect to the rotation axis of said turbomachine. The present invention is applied both to drive turbomachines (turbines) and to working turbomachines (compressors).

Preferably but not exclusively, the present invention regards expansion turbines of radial type for producing electrical and/or mechanical energy.

Preferably but not exclusively, the present invention refers to the radial expansion turbines used in apparatuses for producing energy by means of steam Rankine cycle or organic Rankine cycle (ORC).

Preferably but not exclusively, the present invention refers to the expansion turbines of centrifugal radial or “outflow” type, with this term intending that the fluid flow is radially directed from the center towards the periphery of the turbine.

### BACKGROUND OF THE FINDING

The public document WO 2012/143799, on behalf of the same Applicant, illustrates an expansion turbine which comprises a fixed case having an axial inlet and a radially peripheral outlet, a single rotor disc mounted in the casing and rotatable around a respective rotation axis, multiple annular series of rotor blades mounted on a front face of the rotor disc and arranged around the rotation axis, multiple annular series of stator blades mounted on the case, facing the rotor disc and radially alternated with the rotor blades.

The public document WO 2013/108099 illustrates a turbine for the expansion of an organic fluid in a Rankine cycle provided with arrays of rotor and stator blades that are alternated with each other in a radial direction. The supply of the steam in the turbine is obtained in a frontal direction. In a first section of the turbine, defined at high-pressure, a first expansion of the working fluid is provided in a substantially radial direction. In a second section, defined at low-pressure, a second expansion of the working fluid is provided in a substantially axial direction. The stator blades are supported by an external casing of the turbine.

The public document U.S. Pat. No. 7,244,095 illustrates a centrifugal radial turbine in which the steam is radially expanded towards the exterior. The turbine comprises a single expansion stage provided with stator blades configured in order to accelerate the steam at a high speed. Metal projections are carried by the blades of the rotor and seal against fixed surfaces of abradable type, in a manner so as to limit the passage of steam which would otherwise go around the rotor blades.

The document DE 721 543 illustrates a turbomachine comprising rotor blade rings, and stator blade rings sealed between them. The seals comprise seal plates arranged on a ring and facing a surface of the adjacent ring. DE 721 543 underlines the fact that the seal plates and the corresponding surfaces are placed in zones of the rings such that during the operation of the turbomachine, they maintain the same relative position as when the turbomachine is stopped. The sealing zones, during operation, behave as if they were stopped.

The document GB 594,203 illustrates radial turbomachines (turbines or compressors) provided with blade rings and seal strips arranged between them. Such strips are tilted in order to allow the axial movement of the rings with respect to each other, for the purpose of mounting/dismantling such rings.

The document FR428778 illustrates labyrinth seals for steam or gas turbines. Such document describes seals arranged between the disc and the casing of the turbine with shape (with tilted and thin end edges) such to avoid being ruined when they slide against each other. FR428778 also describes the relative movement between the gaskets due to the axial movement between the discs due to the pressure differences.

The turbomachines are usually characterized by conditions of the entering fluid (pressure and temperature) that are different from the conditions of the same fluid upon exiting. In the expansion turbines (drive turbomachines) like those described above, the entering fluid is situated at a higher pressure and temperature condition than the exiting fluid. In the working turbomachines, inlet pressure and temperature are instead lower than that at the outlet.

The pressure difference between the interior of the turbomachine and the outside environment, the pressure difference between the expansion volume (where the blades operate) and the portions inside the machine but separate from said expansion volume as well as the pressure differences between different portions of the expansion volume corresponding to different stages cause leaks of the working fluid through the zones of coupling between fixed (stator) parts and rotating (rotor) parts of the turbomachine. The fluid in fact tends to be moved from settings with higher pressure towards settings at lower pressure. Such leakage is damaging, since it contributes in an important way to decreasing the efficiency of the turbomachine.

The Applicant has observed that the known solutions adapted to limit the abovementioned leakage, such as that described in the document U.S. Pat. No. 7,244,095 (seals constituted by metal projections and by fixed surfaces of abradable type), are not sufficiently effective.

The Applicant has also observed that, during the assembly of the known turbomachines, in particular during the coupling of the stator parts with the rotor parts, it frequently occurs that the delicate elements (metal projections) of the seals come to slide/impact against other parts of the turbomachine before reaching their correct assembly position. In this manner, there is the risk of ruining the seals, which therefore are no longer able to correctly work and provide the design performances to the turbomachine.

### SUMMARY

In such context, the Applicant has observed that the above-described turbomachines can be improved with regard to various aspects, in order to increase efficiency thereof.

In particular, the Applicant has perceived the need to reduce, to a minimum, the leakage of working fluid through the seals while the turbomachine is operating.

The Applicant has also perceived the need to ensure that, during mounting of the turbomachine, the elements constituting said seals are not ruined.

Therefore, the objective of the present invention is to propose a radial turbomachine with improved efficiency and easier assembly.

The Applicant has found that the above-indicated objectives and still others can be reached by exploiting the radial expansion of the rotor parts, due to the centrifugal force and/or to the heat to which said rotor parts are subjected during the running of the radial turbomachine, in order to move said rotor parts closer to respective stator parts at the seals and thus ensure the substantial absence of leakage or decrease of leakage with respect to the turbomachines of known type.

In particular, the above-indicated objectives and still others are substantially attained by a radial turbomachine according to one or more of the enclosed claims and/or in accordance with one or more of the following aspects.

In the present description and in the enclosed claims, with the adjective “axial” it is intended to define a direction directed parallel to a rotation axis “X-X” of the turbomachine. With the adjective “radial” it is intended to define a direction directed like rays extended orthogonally from the rotation axis “X-X”. With the adjective “circumferential” it is intended directions tangent to circumferences coaxial with the rotation axis “X-X”.

More specifically, according to one aspect, the present invention regards a radial turbomachine, comprising:

a fixed casing;
at least one rotor disc installed in the casing and rotatable in the casing around a respective rotation axis;
a plurality of annular rotor elements coaxial with the rotation axis, axially projecting from a front face of the rotor disc and/or from a rear face of the rotor disc;
a plurality of annular fixed elements coaxial with the rotation axis, axially projecting from the casing and each positioned in a radially external position with respect to a respective annular rotor element;
a plurality of sealing devices radially interposed between at least some of said annular rotor elements and the respective annular fixed elements;
wherein the annular rotor elements are radially movable between a first radially contracted configuration, when the turbomachine is in a non-operative condition, in which, at said sealing devices, said annular rotor elements are radially spaced from the respective annular fixed elements, and a second radially expanded configuration under the action of the centrifugal force and/or of the heat, when the turbomachine is operating, in which, at the sealing devices, said annular rotor elements are close to the respective annular fixed elements;
wherein in the second configuration the sealing devices substantially prevent the passage of a working fluid between the annular rotor elements and the annular fixed elements.

In one aspect, in the first configuration, said annular rotor elements are radially spaced from the respective annular fixed elements to an extent such that they do not necessarily ensure the seal but do allow the mutual approaching (during mounting of the turbomachine) or the mutual moving away (during dismantling of the turbomachine) along an axial direction between the rotor disc and the annular fixed elements, without said annular fixed elements and the annular rotor elements interfering with each other.

In one aspect, the present invention regards a method for mounting a radial turbomachine according to the preceding aspects, wherein the method comprises:
preparing a first half-part of the fixed casing having at least part of the annular fixed elements;
preparing said at least one rotor disc;
placing the first half-part coaxial with said at least one rotor disc with the annular fixed elements facing the annular rotor elements;
moving the first half-part and said at least one rotor disc axially close to each other, until each of the annular fixed elements is placed in radially external position with respect to the respective annular rotor element;
wherein during mounting the annular rotor elements are in the first radially contracted configuration so as to not interfere with the annular fixed elements during the mutual axial approaching of the first half-part and said at least one rotor disc.

In one aspect, the method comprises:
preparing a second half-part of the fixed casing having at least part of the annular fixed elements;
placing the second half-part coaxial with said at least one rotor disc with the annular fixed elements facing the annular rotor elements;
moving the second half-part and said at least one rotor disc axially close to each other, until each of the annular fixed elements is placed in radially external position with respect to the respective annular rotor element.
joining the second half-part to the first half-part in order to close said at least one rotor disc between them;
   wherein during mounting, the annular rotor elements are in the first radially contracted configuration so as to not interfere with the annular fixed elements during the mutual axial approaching of the second half-part and said at least one rotor disc.

In one aspect, the present invention relates to a method for dismantling a radial turbomachine according to the preceding aspects, wherein the method comprises:
axially and mutually moving the first half-part and/or the second half-part away from said at least one rotor disc;
   wherein during dismantling, the annular rotor elements are in the first radially contracted configuration so as to not interfere with the annular fixed elements during mutual axial movement of the first half-part and/or the second half-part away from said at least one rotor disc.

The Applicant has verified that the claimed solution allows ensuring the seal between the annular rotor elements and the annular fixed elements when necessary, i.e. during the operation of the turbomachine, by exploiting the inertial and/or thermal forces that are generated during operation.

In addition, the Applicant has verified that the claimed solution allows facilitating the mounting and dismantling of the turbomachine when the seal is not necessary. In the first configuration, the axial release is in fact ensured without interference of the half-parts and said at least one rotor disc.

In one aspect, in the passage between the first and the second configuration, the relative radial movement between the annular rotor elements and the respective annular fixed elements at said sealing devices is comprised between about 0.05 mm and about 1.4 mm.

In one aspect, said relative radial movement is comprised between about 0.1 mm and about 0.5 mm.

The extent of the radial expansion/contraction of the annular rotor elements at the sealing devices is such to ensure the seal between the annular rotor elements and the annular fixed elements when the turbomachine is operating and to facilitate the mounting and dismantling of the turbomachine when the turbomachine is stopped. In one aspect, the sealing devices comprise a plurality of projections integral with the annular rotor elements and a plurality of surfaces belonging to the annular fixed elements and/or seats obtained in the annular fixed elements.

In one aspect, the sealing devices comprise a plurality of projections integral with the annular fixed elements and a plurality of surfaces belonging to the annular rotor elements and/or seats obtained in the annular rotor elements.

In one aspect, said surfaces are bottom walls of said seats.

In one aspect, in the first configuration, terminal ends of said projections lie spaced from said surfaces and/or outside said seats and in the second configuration said terminal ends are close to said surfaces and/or inserted in said seats.

In one aspect, in the first configuration, terminal ends of said projections brush against or are spaced from said surfaces and/or outside said seats and in the second configuration said terminal ends are abutted against said surfaces and/or inserted in said seats.

In one aspect, the projections are rigid bodies substantially like the annular rotor elements or the annular fixed elements carrying said projections.

Each of the projections is preferably a kind of annular wall coaxial with the rotation axis.

In one aspect, the projections are elastically yieldable bodies with respect to the annular rotor elements or the annular fixed elements carrying said projections.

Each of the projections is preferably a brush with flexible bristles, e.g. made of steel or composite materials (such as Kevlar).

In one aspect, in the second configuration, said terminal ends of the flexible projections push against said surfaces and the projections are radially compressed.

In one aspect, the radial compression of the flexible projections, i.e. their deformation along radial directions in the passage between the first and the second configuration, is comprised between about 0.1 mm and about 0.2 mm, more preferably comprised between about 0.15 mm and about 0.18 mm.

In one aspect, each of the seats is an annular slot coaxial with the rotation axis. When the projections are outside the seats, the axial mutual sliding (during mounting or dismantling of the turbomachine) between the annular rotor elements and the annular stator elements is allowed, without said projections risking interference with the elements carrying the seats.

In one aspect, in the second configuration, the distance “V1” between the terminal ends of the projections and bottom walls of the seats is comprised between about 0.2 mm and about 0.4 mm, more preferably between about 0.25 mm and about 0.35 mm.

In one aspect, in the first configuration, the distance “V2” between the terminal ends of the walls and a radially inner surface of the annular fixed elements, placed outside the seats, is comprised between about 0.15 mm and about 0.8 mm, more preferably between about 0.2 mm and about 0.7 mm.

In one aspect, in the second configuration, said terminal ends enter into said seats for a depth comprised between about 0.1 mm and about 0.6 mm, more preferably comprised between about 0.2 mm and about 0.4 mm.

When the projections are within the seats, the inner walls of said seats in cooperation with the projections delimit a narrow, winding axial path that prevents/limits the leakage of the working fluid.

In one aspect, in the second configuration, said terminal ends are inserted in said seats and remain spaced from a bottom of said seats.

In this manner the seal is ensured without the projections and/or seats being ruined via mutual sliding/abrading.

In one aspect, each annular fixed element or annular rotor element has a plurality of axially adjacent seats.

In one aspect, each annular fixed element or annular rotor element has a plurality of axially adjacent projections.

By increasing the number of the seats and the projections, it is possible to increase the sealing effect.

In one aspect, the seats of a same annular fixed element or annular rotor element are placed at a same radial distance from the rotation axis.

In one aspect, the annular slots constituting the seats of a same annular fixed element or annular rotor element are coaxial and have the same diameter.

In one aspect, the annular slots constituting the seats of a same annular fixed element or annular rotor element have the same radial depth.

In one aspect, the seats of an annular fixed element or annular rotor element are placed at a radial distance from the rotation axis progressively decreasing starting from a free terminal end of said annular fixed element or annular rotor element towards the front face of the rotor disc and/or the rear face of the rotor disc or the casing.

In one aspect, the annular slots forming the seats are coaxial and have decreasing diameters starting from a free terminal end of said annular fixed element or annular rotor element towards the front face of the rotor disc and/or the rear face of the rotor disc or the casing.

In one aspect, the annular slots forming the seats of a same annular fixed element or annular rotor element have different radial depth.

In one aspect, one surface of the annular fixed element or annular rotor element carrying said seats is cylindrical.

In one aspect, one surface of the annular fixed element or annular rotor element carrying said surfaces or said seats is substantially conical (or step-like) and converging towards the front face of the rotor disc and/or the rear face of the rotor disc or the casing.

In one aspect, the seats are made of the material of the annular fixed element or annular rotor element (e.g. of steel or alloys thereof), preferably via removal of material or via molding or via melting.

In one aspect, said surfaces are part of an insert or a covering made of a softer material than the material of the annular fixed element or annular rotor element.

In one aspect, the seats are made of a softer material than the material of the annular fixed element or annular rotor element. Such material comprises, for example, polymer materials (i.e. PTFE, Teflon), impregnated graphites, metals with low melting temperature (i.e. brass, aluminum), preferably with porous structure (sintered powders) or honeycomb structure.

In one aspect, the annular fixed element or annular rotor element comprises an insert made of said softer material carrying said seats or having said surfaces.

In one aspect, the annular fixed element or annular rotor element comprises a covering made of said softer material carrying said seats or having said surfaces.

In one aspect, said seats in the softer material are made, during the initial stage and/or the first operative cycle of the turbomachine, from the projections which, radially expanded, cut said material and dig said seats.

In one aspect, the projections of a same annular fixed element or annular rotor element are arranged at a same radial distance from the rotation axis.

In one aspect, the annular walls forming the projections of a same annular fixed element or annular rotor element are coaxial and have the same diameter.

In one aspect, the annular walls forming the projections of a same annular fixed element or annular rotor element have the same radial height.

In one aspect, the projections of an annular fixed element or annular rotor element are arranged at a radial distance from the rotation axis that is progressively decreasing starting from a free terminal end of said annular fixed element or annular rotor element towards the front face of the rotor disc and/or the rear face of the rotor disc or the casing.

In one aspect, the annular walls forming the projections are coaxial and have decreasing diameters starting from a free terminal end of said annular fixed element or annular rotor element towards the front face of the rotor disc and/or the rear face of the rotor disc or the casing.

In one aspect, the annular walls forming the projections of a same annular fixed element or annular rotor element have different radial heights.

In one aspect, one surface of the annular fixed element or annular rotor element carrying said projections is cylindrical.

In one aspect, one surface of the annular fixed element or annular rotor element carrying said projections is substantially conical (or step-like) and converging towards the front face of the rotor disc and/or the rear face of the rotor disc or the casing.

The arrangement of the projections and/or of the seats of a same annular fixed element or annular rotor element on different diameters and/or the conicity of the surfaces contribute to increasing the sealing effect, still allowing the mutual axial moving away/approaching, without interference, of the annular rotor elements and the annular stator elements.

In one aspect, the projections are integrally made on the annular rotor elements or on the annular fixed elements, e.g. via removal of material, via melting or molding. In one aspect, each of the projections has a triangular shape in a meridian section.

The free vertices of the triangular shapes constitute the ends of the projections which enter into the seats.

In one aspect, the projections are applied to the annular rotor elements or to the annular fixed elements. In one aspect, the projections are plates inserted and fixed in suitable slots in said annular rotor elements or to the annular fixed elements.

In one aspect, the projections are brushes constrained to the annular rotor elements and operatively active against surfaces of the annular fixed elements. In one aspect, in the first configuration, terminal ends of said brushes are spaced from or only graze the surfaces of the annular fixed elements. In one aspect, in the second configuration said terminal ends push against said surfaces of the annular fixed elements and the brushes are radially compressed. In one aspect, the projections are brushes constrained to the annular fixed elements and operatively active against surfaces of the annular rotor elements. In one aspect, in the first configuration, terminal ends of said brushes are spaced from or only graze the surfaces of the annular rotor elements. In one aspect, in the second configuration, said terminal ends push against said surface of the annular rotor elements and the brushes are radially compressed. The surfaces against which the brushes abut are preferably lacking seats.

Each of the brushes comprises a plurality of bristles arranged on a circumference and having first ends constrained to the respective annular fixed or rotor element, preferably inserted and fixed in suitable slots in said annular rotor elements or annular fixed elements. Free ends of the brushes constrained to the annular fixed elements are directed radially inward. Free ends of the brushes constrained to the annular rotor elements are directed radially outward. The bristles are preferably tilted with respect to the respective radial directions in a sense concordant with the rotation sense of the rotor disc.

In one aspect, the annular rotor elements comprise rotor blades mounted on the front face of the rotor disc and the annular fixed elements comprise stator blades facing the front face of the rotor disc. The annular rotor and stator elements therefore constitute the stages of the turbomachine.

In one aspect, the annular rotor elements each comprise an annular rotor band having a first edge joined to the front face of the rotor disc and a second edge opposite the first and provided with an annular rotor joint. The annular rotor joint carries a plurality of rotor blades of a respective rotor stage arranged in succession along a circular path. The leading edges of the rotor blades are extended substantially parallel to the rotation axis. In one aspect, the annular rotor elements each comprise a terminal rotor ring connected to ends of the rotor blades opposite the annular rotor joint. In one aspect, each annular rotor joint carries at least part of the sealing devices. In one aspect, each terminal rotor ring carries at least part of the sealing devices. In one aspect, each of the annular rotor bands has a radial thickness smaller than a radial size of the respective joint and preferably comprised between about ¼ and about 1/10 of the radial size, more preferably comprised between about ⅙ and about ⅛ of said radial size. In one aspect, each of the annular rotor bands has an axial length wherein a ratio between the axial length of the annular rotor band and the respective radial thickness is comprised between about 3 and about 20, more preferably between about 8 and about 12.

Such size confers to the annular rotor band a much lower rigidity than that of the remaining part of the annular rotor element, i.e. of the assembly constituted by the rotor joint, by the rotor blades and by the terminal rotor ring, and therefore leaves said assembly free to be radially expanded (under the effect of the centrifugal force and/or of the heat) in a uniform manner. In other words, the rotor joint and the terminal rotor ring are expanded to a substantially equal extent. The assembly remains substantially parallel to itself during the radial expansion and contraction. In one aspect, the annular fixed elements each comprise a fixed annular band having a first edge joined to the casing and a second edge opposite the first and provided with a fixed annular joint. The fixed annular joint carries a plurality of stator blades of a respective stator stage arranged in succession along a circular path. The leading edges of the stator blades are extended substantially parallel to the rotation axis. In one aspect, the annular stator elements each comprise a terminal stator ring connected to ends of the stator blades opposite the fixed annular joint. In one aspect, each fixed annular joint carries at least part of the sealing devices. In one aspect, each terminal stator ring carries at least part of the sealing devices. In one aspect, each of the annular stator bands has a radial thickness substantially equal to a radial size of the respective stator joint.

The annular fixed elements are not subjected to any centrifugal force. In this manner, during the relative radial movement, the annular rotor elements and the respective annular fixed elements remain parallel to each other at least at the sealing devices.

In one aspect, the annular rotor elements are rotor sealing walls mounted on the rear face of the rotor disc and the annular fixed elements are fixed sealing walls facing the rear face of the rotor disc. The annular rotor and fixed elements therefore constitute sealing walls arranged at the face of the rotor disc opposite that which carries the stator and rotor stages of the turbomachine.

In one aspect, the annular rotor elements each comprise an annular rotor band having a first edge joined to the rear face of the rotor disc and a second edge opposite the first and provided with an annular rotor joint. In one aspect, each annular rotor joint carries at least part of the sealing devices.

In one aspect, each of the annular rotor bands of the rotor sealing walls has a radial thickness smaller than a radial size of the respective joint and preferably comprised between about ¼ and about 1/10 of the radial size, more preferably comprised between about ⅙ and about ⅛ of said radial size. In one aspect, each of the annular rotor bands of the rotor sealing walls has an axial length and wherein a ratio between the axial length of the annular rotor band and the respective radial thickness is comprised between about 3 and about 20, more preferably between about 8 and about 12.

Such size confers to the annular rotor band a rigidity much lower than that of the rotor joint and therefore leaves said joint free to be radially expanded (under the effect of the centrifugal force and/or of the heat) in a uniform manner. In other words, the rotor joint remains substantially parallel to itself during the radial expansion and contraction.

In one aspect, the annular fixed elements defining the fixed sealing walls have a radial thickness that is constant or decreasing towards a free end thereof. Said annular fixed elements are not subjected to any centrifugal force. In this manner, during the relative radial movement, the annular rotor elements and the respective annular fixed elements remain parallel to each other at the sealing devices.

In one aspect, the turbomachine according to the invention is a radial turbine provided with radial stages placed on a single rotor disc, i.e. provided with rotor blades and stator blades. In one aspect, the turbomachine according to the invention is a radial turbine provided with radial stages placed on two facing and counter-rotating rotor discs, i.e. without stator blades. Preferably, said radial turbine is of centrifugal radial type (outflow).

If the turbomachine is a turbine, each annular rotor element provided with blades is subjected to a temperature greater than the respective radially outer stator annular element. It follows that the temperature gradient causes a greater radial expansion for the annular rotor element (which is added to the expansion due to the centrifugal force) with respect to that of the annular stator element. In other words, such temperature gradient assists the annular rotor element in moving closer to the respective radially outer annular stator element (even if the main effect is due to the centrifugal force).

Further characteristics and advantages will be clearer from the detailed description of a preferred but not exclusive embodiment of a radial turbomachine in accordance with the present invention.

### DESCRIPTION OF THE DRAWINGS

Such description will be set forth hereinbelow with reference to the enclosed drawings, provided only as a non-limiting example in which:

FIG. 1 illustrates a meridian section of a first embodiment of a radial turbomachine in accordance with the present invention;

FIG. 2 illustrates a meridian section of a second embodiment of a turbomachine in accordance with the present invention;

FIG. 3 illustrates a detail of the turbine of FIG. 1 in two respective operative configurations;

FIGS. 4, 4A, 5, 5A, 6, 6A and 7 the same number of variants of the detail of FIG. 3;

FIG. 8 illustrates a different detail of the turbine of FIGS. 1 and 2 in respective two operative configurations;

FIG. 9 illustrates a variant of the detail of FIG. 8;

FIG. 10 illustrates the detail of FIG. 3 obtained according to the prior art.

### DETAILED DESCRIPTION

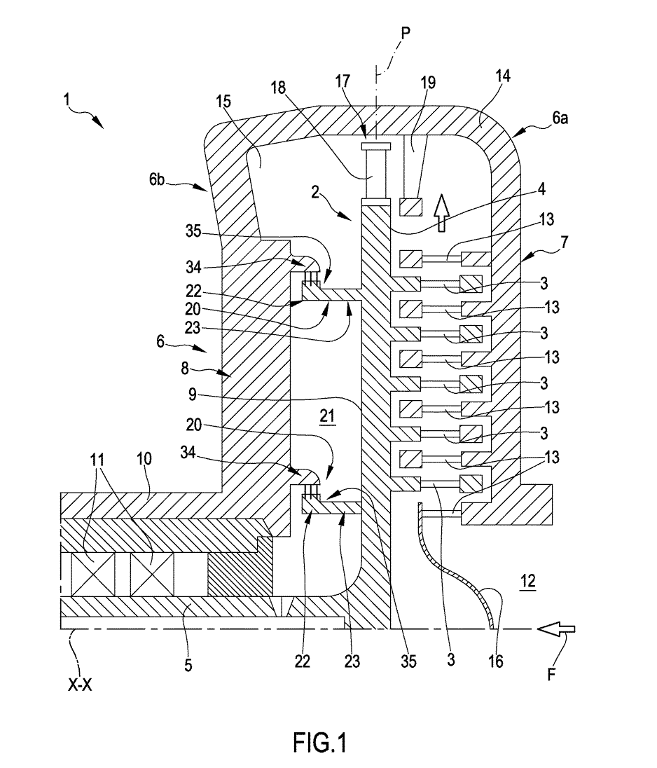

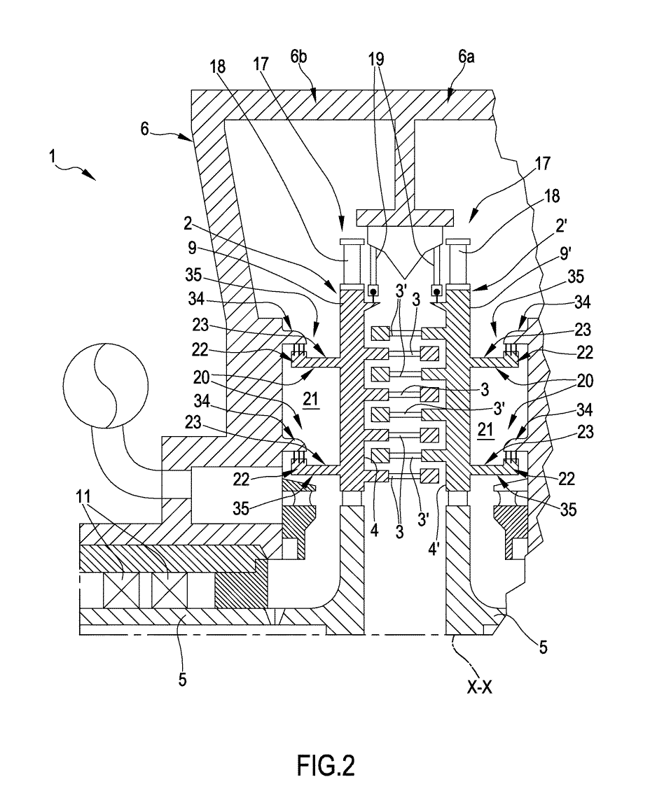

With reference to the abovementioned figures, reference number 1 overall indicates a radial turbomachine in accordance with the present invention. The turbomachine 1 illustrated in FIG. 1 is an expansion turbine of radial outflow type with single rotor disc 2. The turbomachine 1 illustrated in FIG. 2 is an expansion turbine of radial outflow type with two counter-rotating rotor discs 2, 2′. With reference to FIG. 1, the rotor disc 2 is provided with a plurality of rotor blades 3 arranged in a series of concentric rings on a respective front face 4. Each series of rotor blades 3 is part of a rotor stage of the turbine 1. The rotor disc 2 is rigidly connected to a shaft 5 which is extended along a rotation axis “X-X”. The shaft 5 is in turn connected to a generator (not illustrated). The rotor blades 3 are extended away from the front face 4 of the rotor disc 2 with its leading edges substantially parallel to the rotation axis “X-X”.

The rotor disc 2 and the shaft 5 are housed in a fixed casing 6 and are supported by the latter in a manner such that they can freely rotate around the rotation axis “X-X”. The fixed casing 6 is formed by a first half-part 6a and a second half-part 6b mutually coupled and constrainable at a plane “P” perpendicular to the rotation axis “X-X” and placed at the rotor disc 2.

The fixed casing 6 comprises a front wall 7 (part of the first half-part 6a), placed across from the front face 4 of the rotor disc 2, and a rear wall 8 (part of the second half-part 6b), situated across from a rear face 9 of the rotor disc 2 opposite the front face 4. A sleeve 10 is integral with the rear wall 8 and rotatably houses the shaft 5 by means of interposition of suitable bearings 11. The front wall 7 has an inlet opening 12 for a working fluid situated at the rotation axis “X-X”.

The fixed casing 6 also houses a plurality of stator blades 13 arranged in series of concentric rings and directed towards the front face 4 of the rotor disc 2. The series of stator blades 13 are radially alternated with the series of rotor blades 3 to define a radial expansion path of the working fluid which enters through the inlet opening 12 and is expanded radially away towards the periphery of the rotor disc 2. The fixed casing 6 also comprises a radially peripheral wall 14 which is extended from the front 7 and rear 8 walls and internally delimits an outlet volume 15 for the working fluid.

The turbine 1 comprises a deflector or nose 16 defined by a convex wall, placed in the inlet opening 12 and directed towards the entering flow “F”. The deflector 16 radially deflects the entering radial flow “F” towards a first series of stator blades 13 interposed between the front wall 7 of the fixed casing 6 and a radially peripheral portion of the deflector itself 16.

The turbomachine 1 of FIG. 1 comprises an auxiliary axial stage 17 comprising a plurality of auxiliary rotor blades 18 mounted on a peripheral edge of the rotor disc 2 and a plurality of auxiliary stator blades 19 mounted fixed on a radially peripheral wall 14 of the fixed casing 6.

At the rear face 9 of the rotor disc 2, two sealing walls 20 are present, delimiting an annular chamber 21 together with the rear face 9 and the rear wall 8 of the casing 6.

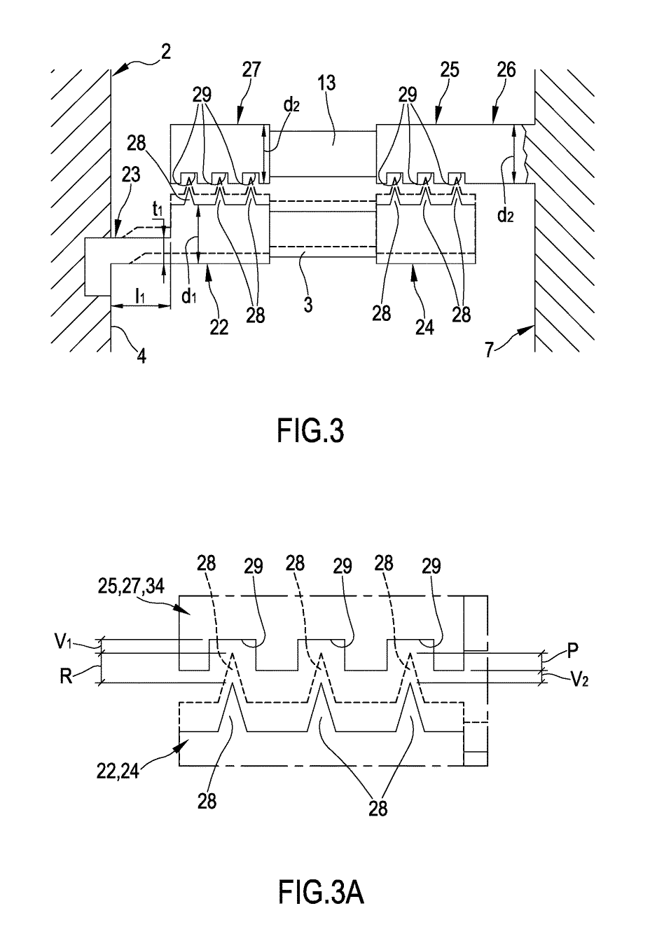

As is better visible in FIG. 3, each series of rotor blades 3 is mounted on a respective annular rotor joint 22 coaxial with the rotation axis “X-X” (FIG. 3 illustrates a meridian section of one stage of the turbine 1 of FIG. 1). The rotor blades 3 of a respective rotor stage are therefore arranged in succession along a circular path defined by the annular rotor joint 22. The annular rotor joint 22 is in turn carried by an annular rotor band 23 having a first edge joined to the front face 4 of the rotor disc 2 and a second edge opposite the first and connected to said annular rotor joint 22. The rotor blades 3 of a same series each have one end (blade root) constrained to the annular rotor joint 22 and an opposite end connected to a terminal rotor ring 24, it too coaxial with the rotation axis “X-X”. The annular rotor joint 22 and the terminal rotor ring 24 substantially have the same diameter and the same radial size “d1”. The annular rotor band 23 instead has a radial thickness “t1” smaller than the radial size “d1”. For example, the ratio between the radial thickness “t1” and the radial size “d1” is about ⅕. In addition, the ratio between the axial length “L1” of the annular rotor band 23 and the respective radial thickness “t1” is for example about 10.

As is visible in FIG. 3, the array of rotor blades 3 is operatively coupled to an array of stator blades 13 of a respective stator stage situated in radially outer position. Each series of stator blades 13 is mounted on a respective fixed annular joint 25 coaxial with the rotation axis “X-X”. The stator blades 13 of the stator stage are therefore arranged in succession along a circular path defined by the fixed annular joint 25.

The fixed annular joint 25 is in turn carried by a fixed annular band 26 having a first edge joined to the front wall 7 of the casing 6 and a second edge opposite the first and connected to said fixed annular joint 25. In the illustrated embodiment, the fixed annular band 26 is integral with the fixed annular joint 25. The stator blades 13 of a same series each have one end (blade root) constrained to the fixed annular joint 25 and an opposite end connected to a terminal stator ring 27, it too coaxial with the rotation axis “X-X”. The fixed annular joint 25, the end ring 27 and the fixed annular band 26 substantially have the same radial size “d2”, which is similar to or substantially equal to the radial size of the annular rotor joint 22 and the terminal rotor ring 24.

The annular rotor joint 22 is radially internal with respect to the terminal stator ring 27 and radially faces said terminal stator ring 27. The terminal rotor ring 24 is radially internal with respect to the fixed annular joint 25 and radially faces said fixed annular joint 25. Also the rotor blades 3 of one stage are radially internal with respect to the stator blades 13 of the same stage and radially face said stator blades 13.

A radially outer surface of the annular rotor joint 22 carries a plurality of annular walls 28 (three of these in the example illustrated in FIG. 3) coaxial with the rotation axis “X-X” and axially side-by-side each other. Each of the annular walls 28 radially projects from the respective radially outer surface and has, in a meridian section, a triangle shape with the free vertex directed towards the terminal stator ring 27. Analogously, a radially outer surface of the terminal rotor ring 24 carries a plurality of annular walls 28 (three of these in the example illustrated in FIG. 3) coaxial with the rotation axis “X-X” and axially side-by-side each other. Each of the annular walls 28 radially projects from the respective radially outer surface and has, in a meridian section, a triangle shape with the free vertex directed towards the fixed annular joint 25. In the embodiment illustrated in FIG. 3, the annular walls 28 are integrally obtained together with, respectively, the terminal rotor ring 24 and the annular rotor joint 22.

A radially inner surface of the terminal stator ring 27 has a plurality of annular seats or slots 29 (three of these in the example illustrated in FIG. 3) coaxial with the rotation axis “X-X” and axially side-by-side each other. Each annular slot 29 radially faces a respective annular wall 28 of the annular rotor joint 22 and has a bottom wall and two side walls. Analogously, a radially inner surface of the fixed annular joint 25 has a plurality of annular seats or slots 29 (three of these in the example illustrated in FIG. 3) coaxial with the rotation axis “X-X” and axially side-by-side each other. Each annular slot 29 radially faces a respective annular wall 28 of the terminal rotor ring 24 and has a bottom wall and two side walls.

In the non-limiting embodiment of FIG. 3, the radially inner surfaces of the terminal stator ring 27 and of the fixed annular joint 25 and the radially outer surfaces of the annular rotor joint 22 and of the terminal rotor ring 24 are cylindrical. In addition, the annular walls 28 all have the same radial height and the annular slots 29 all have the same radial depth.

The annular walls 28 together with the annular slots 29 define sealing devices adapted to prevent/limit the outflow of the working fluid from the radial expansion path of the working fluid in which the rotor blades 3 and stator blades 13 operate. Such sealing devices 28, 29 are not active, or they are active but not so much so as to ensure the necessary seal, when the radial turbine 1 is stopped and cold, i.e. when it is not traversed by the working fluid. In such first configuration (illustrated as a solid line in FIGS. 3 and 3A), the free vertices or terminal ends of the walls 28 lie outside the respective annular slots 29.

Such sealing devices 28, 29 are instead active when the radial turbine 1 is operating, i.e. when the centrifugal force that operates on the rotor disc 2 and/or the temperature gradient due to the working fluid cause a radial expansion of the annular rotor joint 22 and of the terminal rotor ring 24 such that the free vertices or terminal ends of the walls 28 come to be situated within the respective annular slots 29, preferably without touching the bottom walls thereof (dashed line of FIGS. 3 and 3A). Preferably, in the passage between the first and the second configuration, the relative radial movement “R” (FIG. 3A) between the slots 29 and the walls 28 is about 0.8 mm. Preferably, in the second configuration, the distance “V1” between the free vertices or terminal ends of the walls 28 and the bottom walls of the slots 29 is about 0.3 mm (FIG. 3A). Preferably, in the first configuration, the distance “V2” between the free vertices or terminal ends of the walls 28 and the radially inner surface of the fixed annular joint 25 placed outside the slots 29 is about 0.5 mm (FIG. 3A). Preferably, in the second configuration said terminal ends enter into said slots 29 for a depth “P” of about 0.3 mm (FIG. 3A).

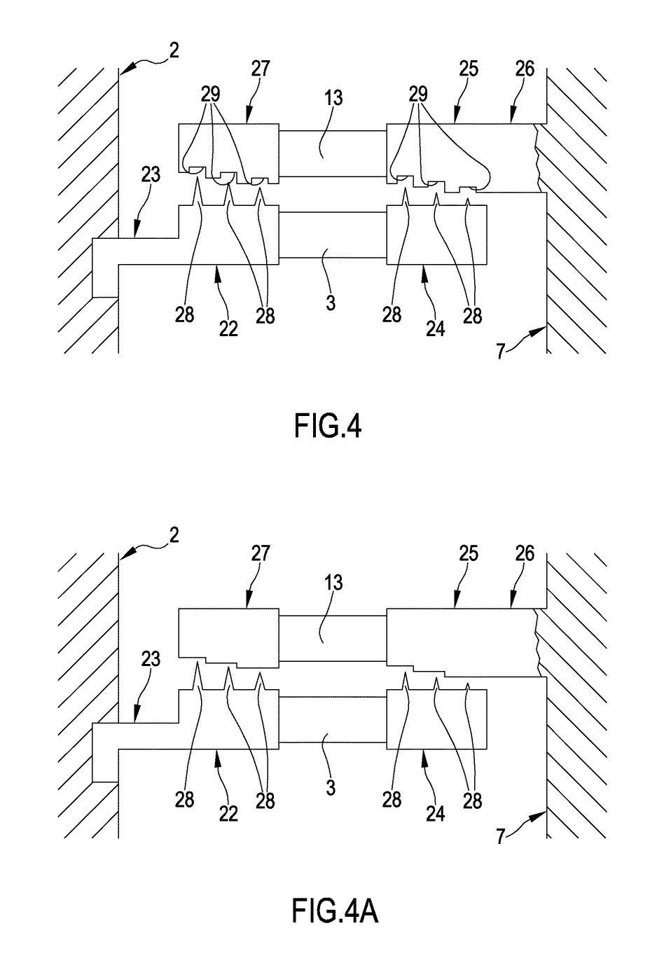

In the variant of FIG. 4, the walls 28 have a radial height that is decreasing starting from a first wall 28 placed at the rotor disc 2 towards a final wall 28 placed at the front wall of the casing 7. In addition, the radially inner surfaces of the fixed annular joint 25 and of the terminal stator ring 27 are conical and converging towards the front wall of the casing 7. The annular slots 29 all have the same radial depth but are situated, due to their positioning on the conical surfaces, at a radial distance from the rotation axis that is progressively decreasing from a first slot 29 placed at the rotor disc 2 towards a final slot 29 placed at the front wall of the casing 7.

A further variant, illustrated in FIG. 4A, is substantially similar to that of FIG. 4 but only has steps and does not have the annular slots 29.

In the variant of FIG. 5, unlike the embodiment of FIG. 3, the slots 29 are made of an insert 30 of softer material (e.g. of PTFE) than that of the fixed annular joint 25 and of the terminal stator ring 27 (which are usually made of steel). The insert 30 is mounted in a suitable housing made in the radially inner surface respectively of the fixed annular joint 25 and of the terminal stator ring 27.

In the variant of FIG. 5A, the insert 30 is not provided with slots, and the walls 28 in the second configuration only move closer to the insert 30.

In the variant of FIG. 6, the slots 29 are obtained in the radially outer surfaces of the annular rotor joint 22 and of the terminal rotor ring 24. In place of the annular walls 28, the fixed annular joint 25 and the terminal stator ring 27 carry, on a radially inner surface, a plurality of plates 31 inserted and fixed in suitable slots (not illustrated). The plates 31 are intended to be partially inserted in the respective slots in a manner analogous to the walls 28. In this case, it is the annular slots 29 that are radially moved outward in order to receive said plates 31. In the variant of FIG. 6A, the radially outer surfaces of the annular rotor joint 22 and of the terminal rotor ring 24 are not provided with slots and the plates 31 in the second configuration are only moved closer to said surfaces.

In the embodiment of FIG. 7, in place of the walls 28 or of the plates 31, the fixed annular joint 25 and the terminal stator ring 27 are each provided with a brush 32. Each of the brushes 32 comprises a plurality of bristles (e.g. made of steel) arranged on a circumference and having first ends constrained to the respective fixed annular joint 25 and terminal stator ring 27, preferably inserted and fixed in suitable slots. Free ends of the brushes 32 are directed radially inward and respectively towards the annular rotor joint 22 and the terminal rotor ring 24. Unlike the above-described embodiments, the variant of FIG. 7 does not have annular slots. The free ends of the brushes 32 in fact operate against smooth surfaces respectively of the annular rotor joint 22 and of the terminal rotor ring 24. In the first configuration, the terminal ends of said brushes 32 are spaced from or only graze said smooth surfaces and in the second configuration said terminal ends push the brushes 32 against said smooth surfaces and they are radially compressed/deformed/crushed and/or the bristles are bent. The radial compression of the brushes 32, i.e. their deformation along radial directions in the passage between the first and the second configuration, is for example about 0.16 mm. In the embodiment of FIG. 7, at both sides of each of the brushes 32, annular protection walls 33 are situated which remain in any case spaced from the smooth surfaces even in the second configuration.

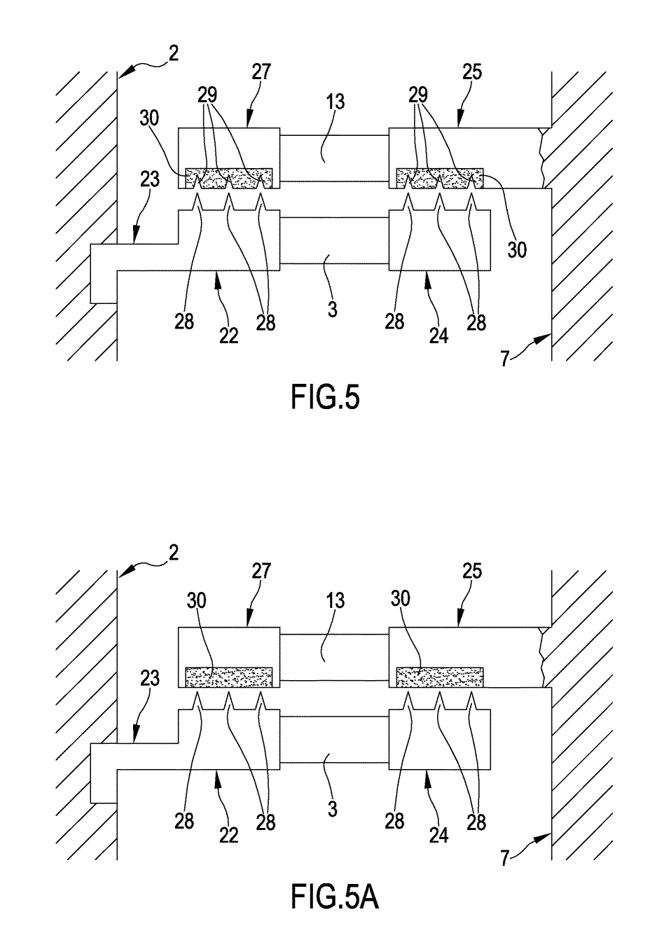

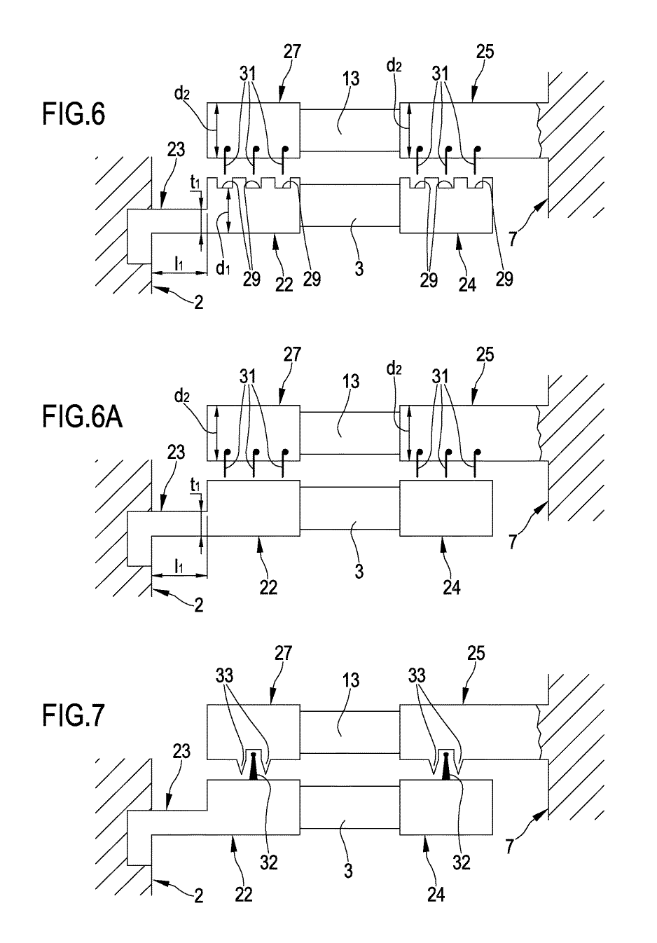

As is more visible in FIGS. 8 and 9, the sealing walls 20 delimiting the annular chamber 21 have a structure similar to that described for the support elements of the rotor blades 3. In particular, each of the two sealing walls 20 illustrated comprises a fixed sealing wall 34 integral with the casing 6 and extended within the casing 6 from the rear wall 8 towards the rotor disc 2. Each of the two sealing walls 20 illustrated also comprises a rotor sealing wall 35 mounted on the rear face 9 of the rotor disc 2 and extended towards the rear wall 8 of the casing 6.

The fixed sealing wall 34 of FIG. 8 has its radially inner surface cylindrical and provided with a plurality of annular slots 29 (three of these in the illustrated example) structurally similar to those described for the fixed annular joint 25 or for the terminal stator ring 27 of FIG. 3.

The rotor sealing wall 35 of FIG. 8 comprises an annular rotor band 23 having a first edge joined to the rear face 9 of the rotor disc 2 and a second edge opposite the first and provided with an annular rotor joint 22. The geometry of the rotor sealing wall 35 is therefore analogous to the assembly formed by the annular rotor joint 22 and by the annular rotor band 23 which carry the rotor blades 3 of FIG. 3. The annular rotor band 23 has a radial thickness “t1” smaller than the radial size “d1” of the annular rotor joint 22. For example, the ratio between the radial thickness “t1” and the radial size “d1” is about ⅕. In addition, the ratio between the axial length “L1” of the annular rotor band 23 and the respective radial thickness “t1” is, for example, about 5.

A radially outer surface of the annular rotor joint 22 carries a plurality of walls 28 structurally similar to those previously described with reference to the joint 22 that carries the rotor blades 3.

The annular walls 28 together with annular slots 29 define sealing devices adapted to prevent/limit the passage of the working fluid between the sealing chamber 21 and other zones inside the fixed casing 6. The functioning principle of the sealing walls 20 is the same as that of the rotor and stator stages, i.e. the sealing devices 28, 29 are active when the radial turbine 1 is operating.

FIG. 3A also represents an enlarged view of the annular rotor joint 22 belonging to the rotor sealing wall 35 and of a part of the fixed sealing wall 34. Preferably, in the passage between the first and the second configuration, the relative radial movement “R” (FIG. 3A) between the slots 29 and the walls 28 is about 0.8 mm. Preferably, in the second configuration, the distance “V1” between the free vertices or terminal ends of the walls 28 and the bottom walls of the slots 29 is about 0.3 mm (FIG. 3A). Preferably, in the first configuration, the distance “V2” between the free vertices or terminal ends of the walls 28 and the radially inner surface of the fixed annular joint 25 placed outside the slots 29 is about 0.5 mm (FIG. 3A). Preferably, in the second configuration, said terminal ends enter into said slots 29 for a depth “P” of about 0.3 mm (FIG. 3A).

In the variant illustrated in FIG. 9, the fixed sealing wall 34 of FIG. 8 has its radially inner surface conical and converging towards the rear wall 8 of the fixed casing 6. The annular slots 29 (three of those in the illustrated example) are structurally similar to those described for the fixed annular joint 25 or for the terminal stator ring 27 of FIG. 4. The walls 28 have a radial height that is increasing starting from a first wall 28 placed at the rear wall 8 towards a final wall 28 spaced from said rear wall 8. The geometry of the fixed sealing wall 34 is therefore analogous to that of the fixed annular joint 25 and of the terminal stator ring 27 of FIG. 4.

The assembly formed by the annular rotor band 23, by the annular rotor joint 22, by the rotor blades 3 and by the terminal rotor ring 24 and the assembly formed by the annular rotor band 23 and by the annular rotor joint 22 of the rotor sealing wall 35 each constitute an annular rotor element that can be radially deformed between the first and the second configuration.

The radial turbine 1 of FIG. 2 is provided with two counter-rotating discs 2, 2′. Elements corresponding to those illustrated and described for the radial turbine of FIG. 1 were indicated with the same reference numbers.

The fixed casing 6 houses a first rotor disc 2 and a second rotor disc 2′ at its interior. The rotor discs 2, 2′ can freely rotate, each independently from the other, in the casing 6 around a common rotation axis “X-X”. For such purpose, the first disc 2 is integral with a respective rotation shaft 5 mounted in the casing 6 by means of bearings 11. The second disc 2′ is integral with a respective rotation shaft 5 mounted in the casing 6 by means of respective bearings.

The first rotor disc 2 has a front face 4 which carries a plurality of radial rotor stages arranged radially in succession one after the other. Each of said radial rotor stages comprises a plurality of blades 3 arranged as an array along a circular path concentric with the rotation axis “X-X”. In other words, the circular arrays of blades 3 of the different stages form concentric rings.

The second rotor disc 2′ has a respective front face 4′ which carries a plurality of radial rotor stages radially arranged in succession one after the other. Each of said radial rotor stages comprises a plurality of blades 3′ arranged as an array along a circular path concentric with the rotation axis “X-X”. In other words, the circular arrays of blades 3′ of the different stages form concentric rings.

The front face 4 of the first rotor disc 2 is placed across from the front face 4′ of the second rotor disc 2′ and the blades 3 of the first disc 2 are radially alternated with the blades 3′ of the second disc 2′. In other words, the radial rotor stages of the first rotor disc 2 are alternated along radial directions with the radial rotor stages of the second rotor disc 2′. The blades 3 of the first disc 2 terminate in proximity to the front face 4′ of the second disc 2′ and the blades 3′ of the second disc 2′ terminate in proximity to the front face 4 of the first disc 2.

The counter-rotating radial turbine 1 of FIG. 2 comprises sealing walls 20 placed at the rear faces of the two rotating discs 2, 2′ to delimit respective sealing chambers 23. Said sealing walls 20 are structurally identical/similar to those described above for the turbine of FIG. 1.

The structures of the above-described turbines 1 allow mounting and dismantling said turbines 1 in accordance with the method according to the present invention. In particular with reference to FIG. 1, the illustrated turbine 1 is dismantled by releasing the first half-part 6a from the second half-part 6b. Said first half-part 6a is axially moved away from the second half-part 6b and from the rotor disc 2 by removing the stator stages from the rotor stages without such stages interfering with each other, since the annular rotor elements comprising said blades 3 are in the first radially contracted configuration.

Subsequently, the rotor disc 2 is extracted together with the shaft 5 by removing the rotor sealing walls 35 from the fixed sealing walls 34 without the walls interfering with each other, since said rotor sealing walls 35 are in the first radially contracted configuration.

With reference to FIG. 2, the illustrated turbine 1 is dismantled by releasing the first half-part 6a from the second half-part 6b, axially moving away the two half-parts 6a, 6b and the two disc s 2, 2′ and then extracting the discs 2, 2′ from the respective half-parts 6a, 6b. Also in this case, the rotor sealing walls 35 are removed from the fixed sealing walls 34 without such walls interfering with each other, since said rotor sealing walls 35 are in the first radially contracted configuration.

The turbines 1 are mounted, in accordance with the present invention, by reversing the sequence of the above-described steps.

### NUMERICAL EXAMPLES

The following examples are referred to a centrifugal radial (out-flow) turbine of the type illustrated in FIG. 1, and employed in an ORC plant for the recovery of industrial heat which works with the following parameters:

Working fluid=R245FA (1,1,1,3,3-pentafluoropropane); P in =23 bar; P out=2 bar; T in =190° C.;

Mass Flow=18 Kg/s

All the examples are referred to the stage of the turbine formed by the third rotor and the fourth stator counted started from the rotation axis towards the exterior.

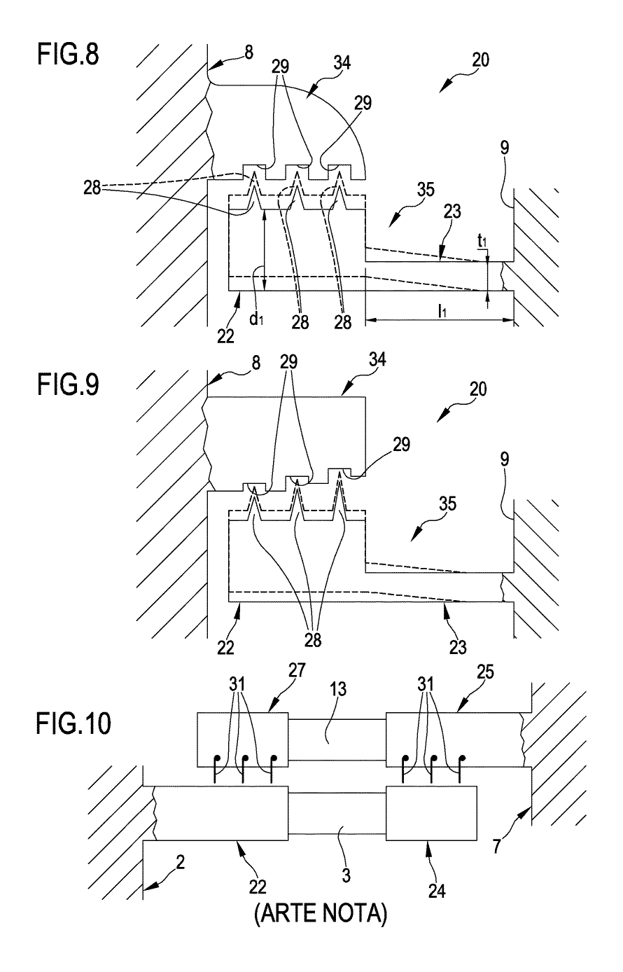

### Example 1—FIG. 10—State of the Art

Such example is referred to the structure belonging to the prior art and illustrated in FIG. 10 in which the annular rotor joint 22 (the same reference numbers of the invention were used for an easier comparison) is constrained to the rotor disc 2 in a manner such that it is not free to be radially expanded under the action of the centrifugal force (indeed the annular band 23 with limited thickness is absent).

The third rotor and the fourth stator were mounted in a manner such that the distance between the ends of the plates 31 and the surfaces facing thereto is 0.38 mm both under cold (stopped turbine) and hot (operating turbine) conditions.

### Example 2—FIG. 6A—Invention

As can be observed, the structure of the sealing devices (plates 31 facing a surface without slots) is identical to that of FIG. 10 but in this case the presence of the annular band 23 allows the radial expansion of the assembly constituted by the rotor joint 22, by the rotor blades 3 and by the terminal rotor ring 24.

The third rotor and the fourth stator were mounted in a manner such that the distance “V2” between the ends of the plates 31 and the surfaces facing thereto is 0.7 mm under cold conditions (stopped turbine). When the turbine is operating, such distance “V2” is reduced to about 0.38 mm.

### Example 3—FIG. 6—Invention

In this example, the radial expansion of the assembly constituted by the rotor joint 22, by the rotor blades 3 and by the terminal rotor ring 24 causes the insertion of the ends of the plates 31 in the respective slots 29.

The third rotor and the fourth stator were mounted in a manner such that the distance “V2” between the ends of the plates 31 and the radially outer surfaces of the rotor joint 22 and from the terminal rotor ring 24 is about 0.2 mm under cold conditions (stopped turbine). When the turbine is operating, the plates are inserted in the slots 29 for a depth “P” of about 0.12 mm. In addition, during operation, the distance “V1” between the ends of the plates 31 and the bottom of the slots 29 is about 0.38 mm.

### Example 4—FIG. 5A—Invention

The third rotor and the fourth stator were mounted in a manner such that the distance “V2” between the ends of the annular walls 28 and the surfaces of the insert 30 facing thereto is about 0.4 mm under cold conditions (stopped turbine). When the turbine is operating, such distance “V2” is reduced to about 0.08 mm.

### Example 5—FIG. 7—Invention

The third rotor and the fourth stator were mounted in a manner such that the distance “V2” between the ends of the bristles of the brushes 32 and the surfaces facing thereto is about 0.3 mm under cold conditions (stopped turbine). When the turbine is operating, such distance “V2” is eliminated and the bristles are compressed for about 0.02 mm (while the annular protection walls 33 never touch).

The following table shows the mass percentage (with respect to the nominal mass that flows in the expansion volume) which leaks during operation (through the sealing devices) between the terminal rotor ring 24 and the fixed annular joint 25 and then between the annular rotor joint 22 and the terminal stator ring 27 for each of the above-illustrated examples.

TABLE

| | Prior art | Invention | | | |
|---|---|---|---|---|---|
| | Ex. 1 | Ex. 2 | Ex. 3 | Ex. 4 | Ex. 5 |
| | FIG. 10 | FIG. 6A | FIG. 6 | FIG. 5A | FIG. 7 |
| Distance V2 with turbine | 0.379 | 0.7 | 0.2 | 0.4 | 0.3 |
| stopped - first configura- | | | | | |
| tion (mm) | | | | | |
| Distance V2 (or P) with | 0.379 | 0.379 | −0.121 | 0.079 | −0.021 |
| turbine operating - sec- | | | | | |
| ond configuration (mm) | | | | | |
| % leakage between the | 5.14% | 5.14% | 3.63% | 1.21% | 0.58% |
| terminal rotor ring 24 | | | | | |
| and the fixed annular | | | | | |
| joint 25 with turbine | | | | | |
| operating | | | | | |
| % leakage between the | 8.67% | 8.67% | 6.13% | 2.05% | 0.85% |
| annular rotor joint 22 and | | | | | |
| the terminal stator ring | | | | | |
| 27 with turbine operating | | | | | |

As can be observed, the example 2 according to the invention ensures the same seal during operation of the example 1 (solution according to the prior art of FIG. 10), but with turbine stopped allows a much easier mounting/dismantling without risks since the distance between “V2” is a good 0.7 mm.

In all the other examples according to the invention (Ex. 3, 4, 5), the seal during operation is much greater than that of example 1, and yet with turbine stopped the mounting and dismantling are always possible without interference.

1. Radial turbomachine, comprising:
a fixed casing;
at least one rotor disc installed in the casing and rotatable in the casing around a respective rotation axis;
a plurality of annular rotor elements coaxial with the rotation axis, axially projecting from a front face of the rotor disc and/or from a rear face of the rotor disc;
a plurality of annular fixed elements coaxial with the rotation axis, axially projecting from the casing and each positioned in a radially external position with respect to a respective annular rotor element;
a plurality of sealing devices radially interposed between at least some of said annular rotor elements and the respective annular fixed elements;
wherein the annular rotor elements are radially movable between a first radially contracted configuration, when the turbomachine is in a non-operative condition, in which, at said sealing devices, said annular rotor elements are radially spaced from the respective annular fixed elements, and a second radially expanded configuration under the action of the centrifugal force and/or of the heat, when the turbomachine is operating, in which, at the sealing devices, said annular rotor elements are close to the respective annular fixed elements;
wherein in the second configuration, the sealing devices substantially prevent the passage of a working fluid between the annular rotor elements and the annular fixed elements.

2. Turbomachine according to claim 1, wherein the sealing devices comprise a plurality of projections integral with the annular rotor elements or with the annular fixed elements and a plurality of surfaces and/or seats belonging to the annular fixed elements or to the annular rotor elements.

3. Turbomachine according to claim 2, wherein in the first configuration, terminal ends of said projections lie spaced from said surfaces and/or outside said seats, and in the second configuration said terminal ends are close to said surfaces and/or inserted in said seats.

4. Turbomachine according to claim 3, wherein in the second configuration said terminal ends enter into said seats for a depth comprised between about 0.1 mm and about 0.6 mm.

5. Turbomachine according to claim 3, wherein in the second configuration said terminal ends enter into said seats for a depth comprised between about 0.2 mm and about 0.4 mm.

6. Turbomachine according to claim 1, wherein the sealing devices comprise a plurality of projections integral with the annular rotor elements or with the annular fixed elements and a plurality of surfaces belonging respectively to the annular fixed elements or to the annular rotor elements.

7. Turbomachine according to claim 6, wherein in the first configuration, terminal ends of said projections brush against or are spaced from said surfaces, and in the second configuration said terminal ends are abutted against said surfaces.

8. Turbomachine according to claim 7, wherein the projections are elastically yieldable bodies with respect to the annular rotor elements or to the annular fixed elements carrying said projections and wherein, in the second configuration, said terminal ends push against said surfaces and the projections are radially compressed.

9. Turbomachine according to claim 8, wherein the deformation of said projections along radial directions in the passage between the first and the second configuration is comprised between about 0.1 mm and about 0.2 mm.

10. Turbomachine according to claim 8, wherein the deformation of said projections along radial directions in the passage between the first and the second configuration is comprised between about 0.15 mm and about 0.18 m.

11. Turbomachine according to claim 1, wherein the annular rotor elements each comprise an annular rotor band having a first edge joined to the front face or to the rear face of the rotor disc and a second edge opposite the first and provided with an annular rotor joint;
wherein annular rotor joint carries at least part of the sealing devices.

12. Turbomachine according to claim 11, wherein each of the annular bands has a radial thickness smaller than a radial size of the respective annular rotor joint.

13. Turbomachine according to claim 11, wherein each of the annular bands has an axial length and wherein a ratio between the axial length of the annular band and the respective radial thickness is comprised between about 3 and about 20.

14. Turbomachine according to claim 1, wherein the annular rotor elements comprise rotor blades mounted on the front face of the rotor disc and the annular fixed elements comprise stator blades facing the front face of the rotor disc.

15. Turbomachine according to claim 14, wherein the annular rotor elements each comprise an annular rotor band having a first edge joined to the front face or to the rear face of the rotor disc and a second edge opposite the first and provided with an annular rotor joint;
wherein annular rotor joint carries at least part of the sealing devices; and
wherein the annular rotor joint carries a plurality of said rotor blades of a respective rotor stage arranged in succession along a circular path.

16. Turbomachine according to claim 15, wherein the annular rotor elements each comprise a terminal rotor ring connected to ends of the rotor blades opposite the annular rotor joint.

17. Turbomachine according to claim 16, wherein each terminal rotor ring carries at least part of the sealing devices.

18. Turbomachine according to claim 1, wherein the annular rotor elements are rotor sealing walls mounted on the rear face of the rotor disc and the annular fixed elements are fixed sealing walls facing the rear face of the rotor disc.

19. Method for mounting a radial turbomachine obtained according to claim 1, wherein the method comprises:
preparing a first half-part of the fixed casing having at least part of the annular fixed elements;
preparing said at least one rotor disc;
placing the first half-part coaxial with said at least one rotor disc with the annular fixed elements facing the annular rotor elements;
moving the first half-part and said at least one rotor disc axially close to each other, until each of the annular fixed elements is placed in radially external position with respect to the respective annular rotor element.

20. Method according to claim 19, comprising:
preparing a second half-part of the fixed casing having at least part of the annular fixed elements;
placing the second half-part coaxial with said at least one rotor disc with the annular fixed elements facing the annular rotor elements;
moving the second half-part and said at least one rotor disc axially close to each other, until each of the annular fixed elements is placed in radially external position with respect to the respective annular rotor element.
joining the second half-part to the first half-part in order to close said at least one rotor disc between them.

21. Method according to claim 20, wherein during mounting, the annular rotor elements are in the first radially contracted configuration so as to not interfere with the annular fixed elements during the mutual axial approach of the first half-part and the second half-part and of said at least one (2,2′) rotor disc.

22. Method for dismantling a radial turbomachine obtained according to claim 1, wherein the method comprises:
moving the first half-part and/or the second half-part axially and mutually away from said at least one rotor disc.

23. Method according to claim 22, wherein during dismantling, the annular rotor elements are in the first radially contracted configuration so as to not interfere with the annular fixed elements during the mutual axial moving of the first half-part and/or of the second half-part away from said at least one rotor disc.
